(19) United States
(12) Patent Application Publication
(10) Pub. No.: US 2009/0095361 A1
(43) Pub. Date: Apr. 16, 2009

(54) Control value unit for faucet assembly with hot and cold water provided

(76) Inventor: Tien-Ho Chung, Changhua County (TW)

Correspondence Address: Tien-Ho Chung, P.O. Box 44-2049, Taipei, 10668, TW

(21) Appl. No.: 11/907,154

(22) Filed: Oct. 10, 2007

(51) Int. Cl. F16K 15/00

(52) U.S. Cl. 137/594

(57) ABSTRACT

A faucet assembly includes two faucets and two connection pipes are connected to the two faucets. A conjunction portion is connected between the two connection pipes and an outlet pipe extends from the conjunction portion and has outlet. A control valve unit includes two control valves which are respectively received in two respective recesses in the conjunction portion. The two recesses communicate with the outlet pipe. Each control valve includes a sealing member which movably seals the connection pipe corresponding thereto. The water pressure from the other connection pipe cannot move the sealing member so that the water with larger pressure cannot enter the connection pipe in which the water pressure is lower.

### BACKGROUND OF THE INVENTION

(1) Field of the Invention

The present invention relates to a control valve unit for a faucet assembly with hot and cold water provided, the control valve unit prevents cold water from entering the hot water pipe due to pressure difference.

(2) Description of the Prior Art

A conventional faucet assembly generally includes an outlet form which hot water or/and cold water flows. The hot water and the cold water are controlled by two respective handles which are able to be opened or sealed individually so that the user can get the water from the outlet at desired temperature. Some faucet assembly includes a single handle which is rotated or shifted to control the volume of the hot water and the cold water coming from outlet. In either way, the volume of the hot water and the cold water that enter the faucet assembly are controlled by two respective valves. It is noted that the hot water has to be sent to a heater to increase its temperature and then flow to the faucet so that the pressure at the faucet is reduced after a long travel distance. Therefore, when both of the two valves are opened to mix the hot and cold water, the pressure of the cold water is larger than the pressure of the hot water, the cold water tends to push the hot water backward and some cold water enters the hot water pipe. In other words, the user has to wait for a period of time to get the water at desired temperature from the outlet.

The present invention intends to provide a control valve unit for a faucet assembly and includes two control valves located at the two respective paths of hot and cold waters in the faucet assembly. Each control valve includes a sealing member biased by a spring so as to prevent the path from being opened by pressure difference of the hot and cold water.

### SUMMARY OF THE INVENTION

The present invention relates to a faucet assembly which comprises two faucets each include a vale and is connected with an inlet pipe. Two respective handles are connected to the two respective valves to communicate the inlet pipes with the valves. Two connection pipes are connected to the two faucets and a conjunction portion is connected between the two connection pipes. An outlet pipe extends from the conjunction portion and has an outlet. A control valve unit includes two control valves which are respectively received in two respective recesses in the conjunction portion. The two recesses communicate with the outlet pipe. Each control valve includes a sealing member which movably seals the connection pipe corresponding thereto.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the faucet assembly with the control valve unit of the present invention;

FIG. 2 is a cross sectional view to show the faucet assembly with the control valve unit of the present invention;

FIG. 3 is an exploded view to show the control valve unit of the present invention;

FIG. 4 is a cross sectional view to show that the sealing members are not moved and no water enters the outlet pipe;

FIG. 5 is a cross sectional view to show that one of the sealing members is moved to allow water to enter the outlet pipe, and

FIG. 6 is a cross sectional view to show that both of the two sealing members are moved to allow hot and cold water to enter the outlet pipe.

### DETAILED DESCRIPTION OF THE PREFERRED EMBODIMENTS

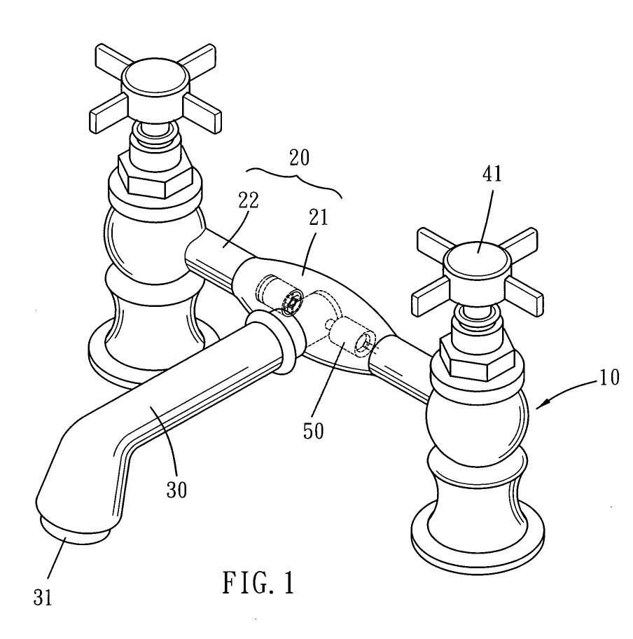

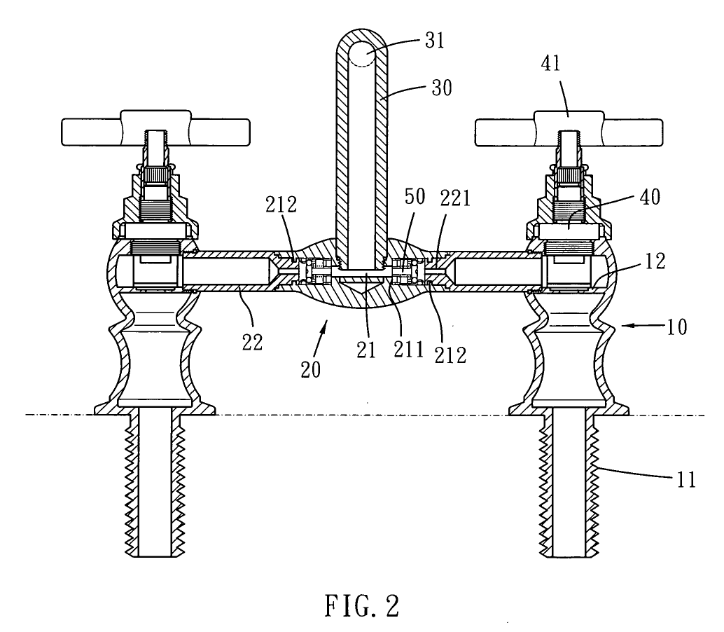

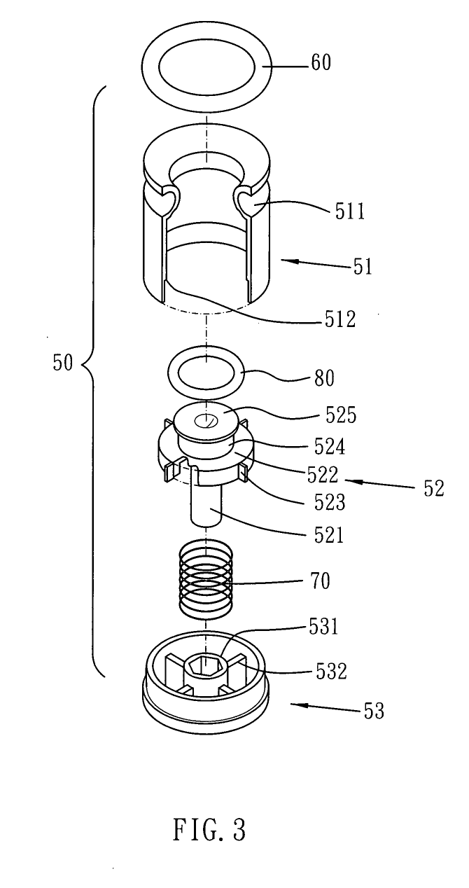

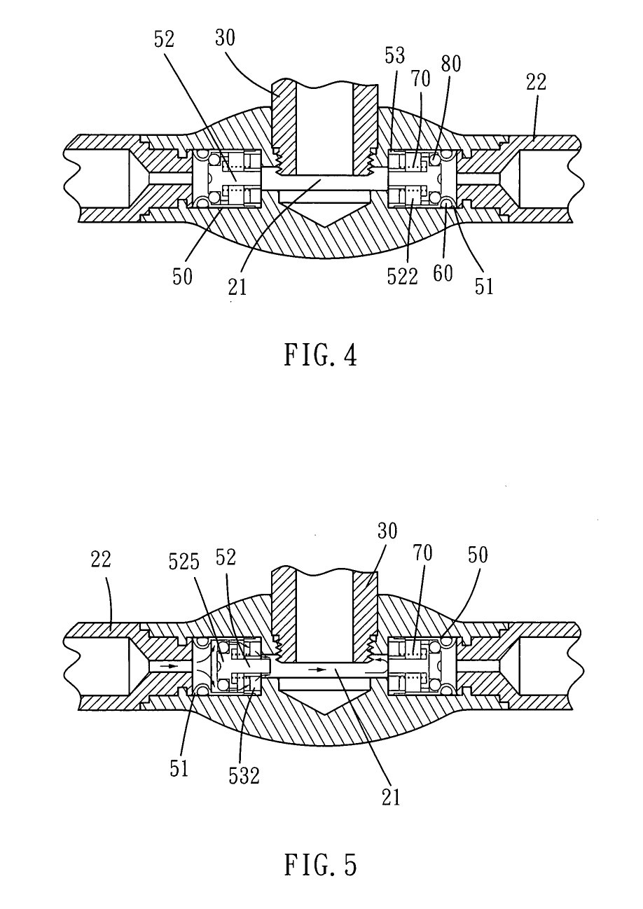

Referring to FIGS. 1 to 4, the faucet assembly of the present invention comprises two faucets 10 and two connection pipes 22 are connected to the two faucets 10. A conjunction portion 20 is connected between the two connection pipes 22 and an outlet pipe 30 extends from the conjunction portion 20 and includes an outlet. Each faucet 10 includes a vale 40 received therein and an inlet pipe 11 is connected to the faucet 10 so as to provide pipe water into the faucet 10. Each faucet 10 includes an engaging hole with which the valve 40 is engaged. Two respective handles 41 are connected to the two respective valves 40 to communicate the inlet pipes 11 with the valve 40.

The conjunction portion 20 includes two recesses and each recess in the conjunction portion 20 includes a lip 212 extending inward from an inner periphery thereof. Each connection pipe 22 includes an engaging notch with which the lip 212 is engaged so that the connection pipes 22 are connected to the conjunction portion 20. Each connection pipe 22 includes a communication path 221 to communicate between the interior of the connection pipe 22 and the interior of the recess. The outlet pipe 30 is threadedly connected to the conjunction portion 20 and communicates with a mixing area 21 in the conjunction portion 20. The mixing area 21 communicates with the two recesses in the conjunction portion 20.

A control valve unit includes two control valves 50 which are respectively received in two respective recesses in the conjunction portion 20. Each control valve 50 includes a sealing member 52 which movably seals the control valve 50 from communication with the communication path 221 and the mixing area 21. Each control vale 50 includes a hollow cylindrical member 51 which has a first open end and a second open end. A groove 511 is defined in an outer periphery of the first open end of the cylindrical member 51 and a first seal 60 is engaged with the groove 511. The first open end faces the valve 40 corresponding thereto and the first seal 60 is in contact with an inner periphery of the recess. An end member 53 is securely connected to a stepped shoulder 512 in the second open end of the cylindrical member 51. A central tube 531 extends from a center of the end member 53 and a through passage is defined axially through the central tube 531. The through passage is defined through the end member 53 and communicates with an interior of the cylindrical member 51. A plurality of connection plates 532 are connected between the central tube 531 and an inner periphery of the end member 53. The sealing member 52 includes a disk 522 and a rod 521 extends from a first side thereof. The rod 521 is movably inserted into the through passage of the central tube 531 and a spring 70 is mounted to the rod 521. A neck 524 extends from a second side of the disk 522 and an end plate 525 is connected to a distal end of the neck 524. A second seal 80 is mounted to the neck 524 and movably seals an opening defined by an inner periphery of an inward protrusion formed by the groove 511. A skirt extends perpendicularly from a periphery of the disk 522 and a plurality of ribs 523 extend radially outward from an outer periphery of the skirt so as to define gaps between an inner periphery of the recess and the outer periphery of the skirt.

As shown in FIG. 5, when one of the handle 41 is rotated to communicate the connection pipe 22 and the inlet pipe 11, water flows into the connection pipe 22 and the recess via the communication path 221. The water pressure pushes the sealing member 52 to compress the spring 70 and water flows through the opening defined by the inner periphery of the inward protrusion formed by the groove 511, the gaps between the inner periphery of the recess and the outer periphery of the skirt and enters the mixing area 21 and flows out from the outlet 31. It is noted that the water cannot push the sealing member 52 of the other control valve 50 because of the spring 70 of that control valve 50 and the water pressure in the other connection pipe 22.

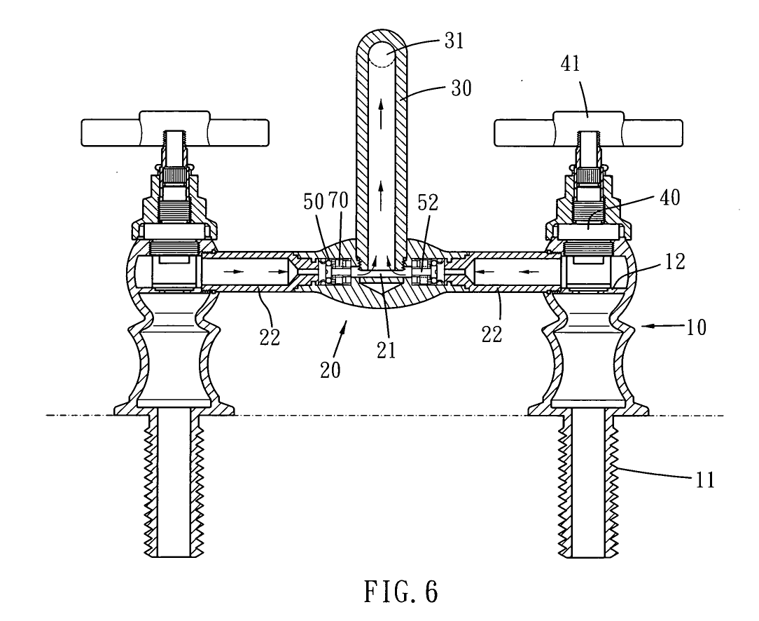

As shown in FIG. 6, the two springs 70 of the two control valves 50 can be set to have different biasing forces, the biasing force of the spring 70 for the cold water is larger than that of the spring 70 for the hot water. This is because the cold water pressure is generally larger than the hot water pressure. By this arrangement, the user rotates the handles 41 the same angular distance will get substantially volume of the hot water and cold water.

While we have shown and described the embodiment in accordance with the present invention, it should be clear to those skilled in the art that further embodiments may be made without departing from the scope of the present invention.

What is claimed is:

1. A faucet assembly comprising:
two faucets each including a vale and connected with an inlet pipe, two respective handles connected to the two respective valves to communicate the inlet pipes with the valve, two connection pipes connected to the two faucets and a conjunction portion connected between the two connection pipes, an outlet pipe extending from the conjunction portion and having an outlet, and
a control valve unit including two control valves which are respectively received in two respective recesses in the conjunction portion, the two recesses communicate with the outlet pipe, each control valve including a sealing member which movably seals the control valve from the outlet pipe and the connection pipe corresponding thereto.

2. The assembly as claimed in claim 1, wherein each control valve includes a hollow cylindrical member which has a first open end and a second open end, a groove defined in an outer periphery of the first open end of the cylindrical member and a first seal is engaged with the groove, the first open end faces the valve corresponding thereto, an end member securely connected to the second open end of the cylindrical member, a through passage defined through the end member and communicates with an interior of the cylindrical member, a sealing member is biased by a spring and movably received in the cylindrical member, a second seal is mounted to the sealing member and movably seals an opening defined by an inner periphery of an inward protrusion formed by the groove.

3. The assembly as claimed in claim 2, wherein a central tube extends from a center of the end member and the through passage is defined axially through the central tube, a plurality of connection plates are connected between the central tube and an inner periphery of the end member, the sealing member includes a disk and a rod extends from a first side thereof, the rod movably inserted into the through passage of the central tube and the spring is mounted to the rod, a neck extends from a second side of the disk and an end plate is connected to a distal end of the neck, the second seal is mounted to the neck.

4. The assembly as claimed in claim 3, wherein a skirt extends perpendicularly from a periphery of the disk and a plurality of ribs extend radially outward from an outer periphery of the skirt so as to define gaps between an inner periphery of the recess and the outer periphery of the skirt.

5. The assembly as claimed in claim 2, wherein the two respective springs have different biasing forces.

7. The assembly as claimed in claim 1, wherein each recess in the conjunction portion includes a lip extending inward from an inner periphery thereof and each connection pipe includes an engaging notch with which the lip is engaged.
